(19) United States
(12) Patent Application Publication
(10) Pub. No.: US 2025/0324213 A1
(43) Pub. Date: Oct. 16, 2025

(54) METHOD FOR OPTIMIZAING IN-VEHICLE SOUND FIELD, SOUND SYSTEM, ELECTRONIC DEVICE AND STORAGE MEDIUM

(71) Applicant: AAC Microtech (Changzhou) Co., Ltd., Changzhou City (CN)

(72) Inventors: Shuyuan Sun, Changzhou (CN); Yiming Meng, Changzhou (CN); Xin Zhang, Changzhou (CN)

(21) Appl. No.: 18/798,875

(22) Filed: Aug. 9, 2024

Related U.S. Application Data
(63) Continuation of application No. PCT/CN2024/087735, filed on Apr. 15, 2024.

(51) Int. Cl. H04S 7/00; H04R 5/02; H04S 3/00; H04S 3/02

(52) U.S. Cl. CPC H04S 7/302; H04R 5/02; H04S 3/008; H04S 3/02; H04R 2499/13; H04S 2400/01; H04S 2400/11

(57) ABSTRACT

Provided is a method for optimizing in-vehicle sound field. In the method, firstly calculates the actual acoustic response of each seat in the cabin to the preset audio signal played by each speaker, and calculates ideal acoustic response of the preset audio signal at the best listening position in the listening room. Then, based on that the actual acoustic response is consistent with the ideal acoustic response, the sound field of each seat in the cabin is reconstructed to obtain the sound field reconstruction result of each seat, so that the sound system controls each speaker to perform the sound reproduction of the audio signal to be played based on the sound field reconstruction result. Therefore, the actual acoustic response at each seat is consistent with the ideal acoustic response of the listening room, thus ensuring the acoustic experience of the passengers at each seat in the cabin.

### TECHNICAL FIELD

The disclosure relates to the technical field of sound reproduction, and in particular to a method for optimizing in-vehicle sound field, a sound system, an electronic device and a storage medium.

### BACKGROUND

A vehicle-mounted sound system is an important component of an in-vehicle entertainment equipment, and may perform sound reproduction in cabins of the automobiles, thereby bringing excellent and immersive driving experience to users. In the related art, the vehicle-mounted sound system includes a plurality of speakers respectively arranged at different positions in the cabin, each speaker may play audio signals for sound reproduction, and sound reproduction of the audio signals in the cabin may be achieved through cooperation of the speakers. Generally, there is a large difference between the physical layout of a plurality of speakers in the cabin and the ideal sound system of a listening room, and the position of the passenger in the cabin is not the ideal listening position in the listening room. In this case, to ensure the acoustic energy/sound field balance between the two ears of the passenger, the size of the sound field must be sacrificed. Then, to ensure the size of the sound field, the acoustic energy/sound field balance between the two ears of the passenger cannot be ensured, and there is an obvious fault in the sound field, that is, the vehicle-mounted sound system cannot take account of the size of the sound field and the acoustic energy/sound field balance between the two ears of the passenger, which undoubtedly reduces the acoustic experience of the passenger in the cabin. Therefore, it is necessary to improve the existing sound reproduction solution in the automobile.

### SUMMARY

The disclosure provides a method for optimizing in-vehicle sound field, a sound system, an electronic device and a storage medium, which aim to solve the problem that the vehicle-mounted sound system in the related art cannot take account of the size of the sound field and the acoustic energy/sound field balance between the two ears of the passenger.

To solve the above technical problem in the related art, a first aspect of the present disclosure provides a method for optimizing in-vehicle sound field applied to a sound system of an automobile, the sound system is disposed in a cabin of the automobile, the sound system includes a plurality of speakers located at different positions in the cabin, each speaker is provided with a digital filter, and the cabin is provided with a plurality of seats. The method for optimizing in-vehicle sound field includes: calculating an actual acoustic response at a target seat according to a preset audio signal, an electro-acoustic conversion transfer function of each speaker, a first acoustic transfer function of each digital filter, and a second acoustic transfer function from each speaker to the target seat in the cabin; calculating an ideal acoustic response at a best listening position according to the preset audio signal, an ideal acoustic transfer function from each preset speaker in a listening room to an optimal listening position, and an ideal electro-acoustic conversion transfer function of each preset speaker; reconstructing the sound field at the target seat based on that the actual acoustic response is consistent with the ideal acoustic response, to obtain a sound field reconstruction result at the target seat; and aggregating and storing the sound field reconstruction results for each seat.

A second aspect of the present disclosure provides a sound system including a domain controller and a plurality of speakers respectively located at different positions in a cabin of the automobile and communicatively connected to the domain controller, the domain controller is configured to implement method for optimizing in-vehicle sound field according to the first aspect of the present disclosure.

A third aspect of the present disclosure provides an electronic device, the electronic device includes a memory and a processor communicatively connected to the memory, the memory stores a computer program, and the processor is configured to call the computer program to implement the method for optimizing in-vehicle sound field according to the first aspect of the present disclosure.

A fourth aspect of the present disclosure provides a non-transitory computer-readable storage medium, the computer-readable storage medium stores a computer program, and the computer program is configured to be called by a processor to implement the method for optimizing an in-vehicle sound field according to the first aspect of the present disclosure.

Through the implementation of the above technical solutions of the present disclosure, the actual acoustic response at the target seat for each speaker to play the preset audio signal is calculated according to the preset audio signal, the electro-acoustic conversion transfer function of each speaker, the first acoustic transfer function of each digital filter and the second acoustic transfer function from each speaker to the target seat, and the ideal acoustic response at the best listening position for each preset speaker to play the preset audio signal is calculated according to the preset audio signal, the ideal acoustic transfer function from each preset speaker in the listening room to the best listening position and the ideal electro-acoustic conversion transfer function of each preset speaker. Then the sound field at the target seat is reconstructed based on the fact that the actual acoustic response is consistent with the ideal acoustic response to obtain the sound field reconstruction result at the target seat. Finally the sound field reconstruction results at each seat is aggregated and stored to complete the optimization of the sound field in the cabin. It can be understood that the sound field reconstruction at each seat in the cabin is based on the fact that the actual acoustic response is consistent with the ideal acoustic response, that is, the sound system may control each speaker to perform the sound reproduction of the audio signal to be played based on the sound field reconstruction result at each seat, and the actual acoustic response at each seat will be consistent with the ideal acoustic response of the listening room. That is, for the passenger sitting on each seat, the acoustic energy/sound field between the two ears is balanced, meanwhile, the sound field size of the passenger is at least consistent with the physical layout of the speakers in the cabin, even the physical space limitation of the cabin is broken through, and the sound field of the passenger does not have an obvious fault, so that the sound field size and the sound energy/sound field balance between the two ears of the passenger are both taken into account, and therefore the acoustic experience of the passenger at each seat in the cabin is improved.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference signs designate corresponding parts throughout the several views.

FIG. 1 is a schematic layout diagram of a speaker in a cabin in the related art;

FIG. 2 is a schematic diagram of auditory impression of a passenger at a driver seat in the related art;

FIG. 3 is another schematic diagram of auditory impression of a passenger at a driver seat in the related art;

FIG. 4 is a block diagram of modules of a sound system according to an embodiment of the present disclosure;

FIG. 5 is a schematic environment diagram of a listening room according to an embodiment of the present disclosure;

FIG. 6 is a schematic diagram of auditory impression of a passenger at a driver seat according to an embodiment of the present disclosure;

FIG. 7 is a schematic layout diagram of a speaker in a cabin according to an embodiment of the present disclosure;

FIG. 8 is a schematic diagram of an acoustic environment of a passenger at a driver seat according to an embodiment of the present disclosure;

FIG. 9 is a schematic diagram of an acoustic environment of a passenger at a passenger seat according to an embodiment of the present disclosure;

FIG. 10 is a schematic diagram of an acoustic environment of a passenger at a rear left seat according to an embodiment of the present disclosure;

FIG. 11 is a schematic diagram of an acoustic environment of a passenger at a rear right seat according to an embodiment of the present disclosure;

FIG. 12 is a block diagram of modules of a domain controller according to an embodiment of the present disclosure;

FIG. 13 is a schematic flowchart of a method for optimizing in-vehicle sound field according to an embodiment of the present disclosure.

### DESCRIPTION OF EMBODIMENTS

In order to make the objects, technical solutions and advantages of the present disclosure more clear and easy to understand, the present disclosure will be clearly and completely described below with reference to the embodiments of the present disclosure and the corresponding drawings. The same or similar reference signs denote the same or similar elements or elements having the same or similar functions throughout. It should be understood that the embodiments of the present disclosure described below are merely used to explain the present disclosure, and are not used to limit the present disclosure. That is, based on the embodiments of the present disclosure, all other embodiments obtained by a person of ordinary skill in the art without creative work fall within the protection scope of the present disclosure. In addition, the technical features involved in the various embodiments of the present disclosure described below may be combined with each other as long as they do not constitute any confliction with each other.

There is a large difference between the physical layout of a plurality of speakers in the cabin of the automobile and the ideal sound system of the listening room, and the position of the passenger in the cabin is not the ideal listening position in the listening room. In this case, to ensure the acoustic energy/sound field balance between the two ears of the passenger, the size of the sound field must be sacrificed. However, to ensure the size of the sound field, the acoustic energy/sound field balance between the two ears of the passenger cannot be ensured, and there is an obvious fault in the sound field. That is, the vehicle-mounted sound system in the related art cannot take account of the size of the sound field and the acoustic energy/sound field balance between the two ears of the passenger, which undoubtedly reduces the acoustic experience of the passenger in the cabin.

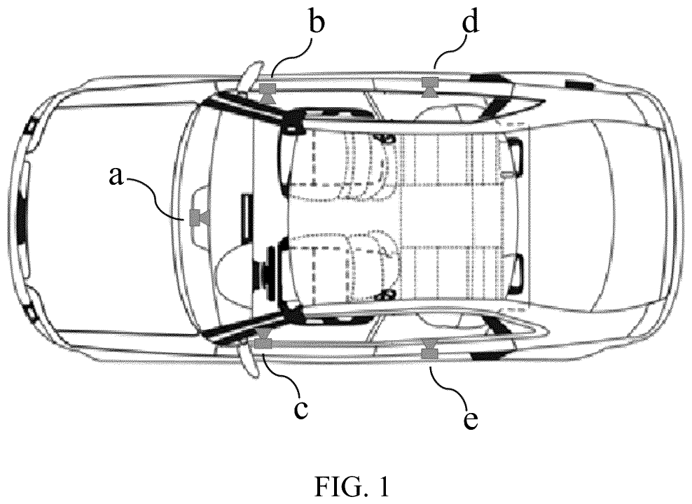

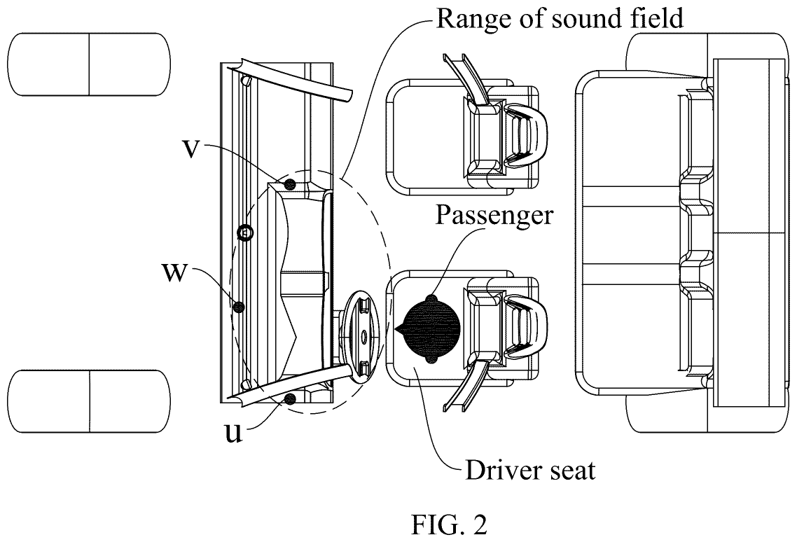

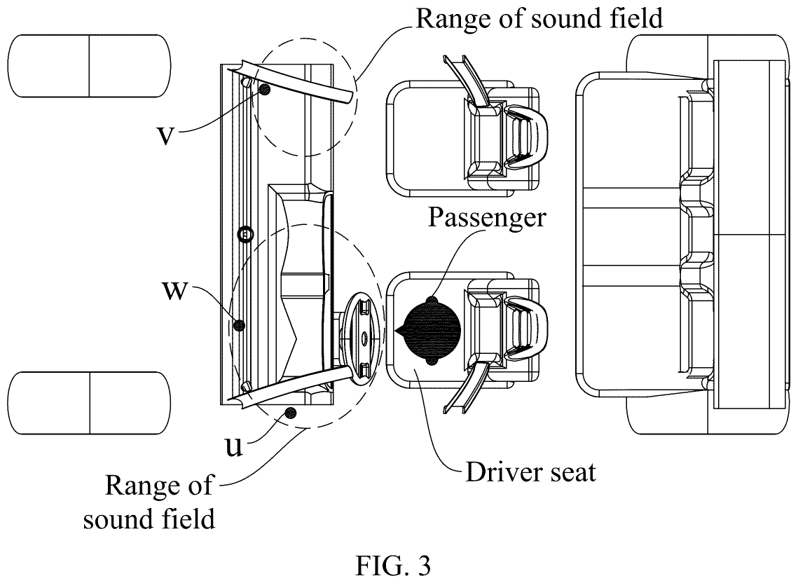

In order to more clearly understand the above disadvantages in the related art, referring to FIG. 1, five speakers (represented by a, b, c, d and e respectively) are disposed in the cabin of the automobile. The speaker a is disposed at the center of the central console, the speaker b is disposed at the position of the right front door close to the head of the automobile, the speaker c is disposed at the position of the left front door close to the head of the automobile, the speaker d is disposed at the position of the right rear door close to the head of the automobile, and the speaker e is disposed at the position of the left rear door close to the head of the automobile. Taking the passenger in the driver seat as an example, the auditory impression may be divided into two cases, namely: as shown in FIG. 2, the elliptical shaded area represents the range of the sound field perceived by the passenger, u, v and w respectively represent the left-channel sound image position, the right-channel sound image position and the center sound image position perceived by the passenger. It can be found from FIG. 2 that the left-channel sound image position u and the right-channel sound image position v are respectively located on the left side and the right side of the passenger, and have good symmetry, so that the sound energy/sound field balance between the two ears of the passenger may be ensured. But the size of the sound field is obviously smaller than the physical layout of the speaker in the cabin, that is, the size of the sound field and the sound energy/sound field balance between the sound field and the two ears of the passenger cannot be taken into account, thereby reducing the acoustic experience of the passenger. As shown in FIG. 3, the elliptical shaded area also represents the range of the sound field perceived by the passenger, u, v and w also represent the left-channel sound image position, the right-channel sound image position and the center sound image position perceived by the passenger. It can be found from FIG. 3 that although the size of the sound field is consistent with the physical layout of the speaker in the cabin, there is an obvious fault in the sound field, and since the center sound image position w is located directly in front of the passenger, the left-channel sound image position u is located on the left side of the passenger and is close to the passenger, the right-channel sound channel sound image is located to the passenger, and is relatively far away from the passenger, so that the sound energy/sound field between the two ears of the passenger cannot be balanced. That is, the size of the sound field and the sound energy/sound field between the two ears of the passenger cannot be taken into account, thereby reducing the acoustic experience of the passenger. Therefore, embodiments of the present disclosure provide a method for optimizing in-vehicle sound field and a sound system using the method thereof, so as to avoid the above disadvantages in the related art.

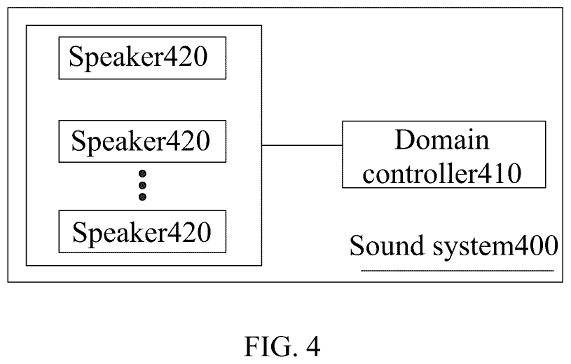

FIG. 4 is a block diagram of modules of a sound system, in some embodiments, the sound system 400 includes a domain controller 410 disposed in the cabin of the automobile and a plurality of speakers 420 located at different positions in the cabin. Each speaker 420 is communicatively connected to the domain controller 410, and the domain controller 410 may transmit an audio signal to be played to each speaker 420 in the cabin, so as to perform sound reproduction of the audio signal to be played in the cabin through each speaker 420, thereby bringing excellent and immersive driving experience to the passenger. Generally, the cabin is enclosed by a housing of an automobile, for example, a door (including but not limited to a left front door, a right front door, a left rear door, and a right rear door), a window, and the like of the automobile are all a part of the housing, a central console close to a head of the automobile, a table console close to a tail of the automobile, and a plurality of seats located between the central console and the table console are further disposed in the cabin. Each seat is available for a passenger to take, for example, a driver seat, a passenger seat, a rear left seat, and a rear right seat or the like. The driver seat and the passenger seat are disposed side by side and adjacent to the central console, and the rear left seat and the rear right seat are disposed side by side and adjacent to the table console. In addition, it should be noted that, for a single speaker 420 at a certain position in the cabin, it is not limited to one speaker 420 in practice, or there may be a plurality of speakers, for example, a two-way or coaxial speaker module composed of two speakers, a three-way speaker module composed of three speakers, and a speaker array composed of multiple speakers, which may be specifically designed according to actual requirements, and is not limited in the present disclosure.

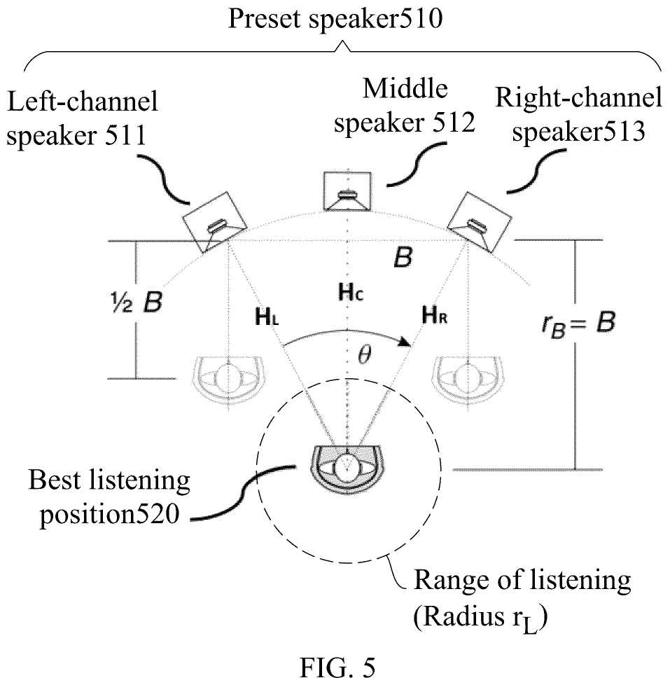

For example, the domain controller 410 stores a computer program, and the computer program is essentially the method for optimizing in-vehicle sound field in the present disclosure. That is, the domain controller 410 is configured to implement the method for optimizing in-vehicle sound field in the present disclosure by executing the stored computer program. In an actual sound field optimization process, a digital filter is applied to each speaker 420, and an actual acoustic response of the target seat for playing the preset audio signal by each speaker 420 is calculated according to the preset audio signal, the electro-acoustic conversion transfer function of each speaker 420, the first acoustic transfer function of each digital filter, and the second acoustic transfer function from each loudspeaker 420 to the target seat in the cabin. Then, referring to FIG. 5, an ideal acoustic response of the best listening position 520 for playing the preset audio signal by each preset speaker 510 is calculated according to the preset audio signal, the ideal acoustic transfer function from each preset speaker 510 in the listening room to the best listening position 520, and the ideal electro-acoustic conversion transfer function of each preset speaker 510. Thus, the sound field at the target seat is reconstructed based on the fact that the actual acoustic response is consistent with the ideal acoustic response to obtain a sound field reconstruction result at the target seat. Finally, the sound field reconstruction result at each seat is summarized and stored, and the stored sound field reconstruction result at each seat is used for the subsequent domain controller 410 to control each speaker 420 to perform sound reproduction of the audio signal to be played. In addition, it should be noted that the listing area in FIG. 5 is the listening range of the user at the best listening position 520, and the radius of the listening range is the radius r_{L}, radius r_{L}≤0.7 m, θ=60°, B=2˜3 m, and the maximum is 4 m. It should be further noted that the method for optimizing in-vehicle sound field of the present disclosure may also be implemented by an external electronic device (such as a computer), but after the electronic device obtains the sound field reconstruction result at each seat in the cabin, the sound field reconstruction result at each seat needs to be transmitted to the domain controller 410, and the domain controller 410 may store the received sound field reconstruction result at each seat, so as to subsequently control each speaker 420 to perform sound reproduction of the audio signal to be played based on the sound field reconstruction result at each seat.

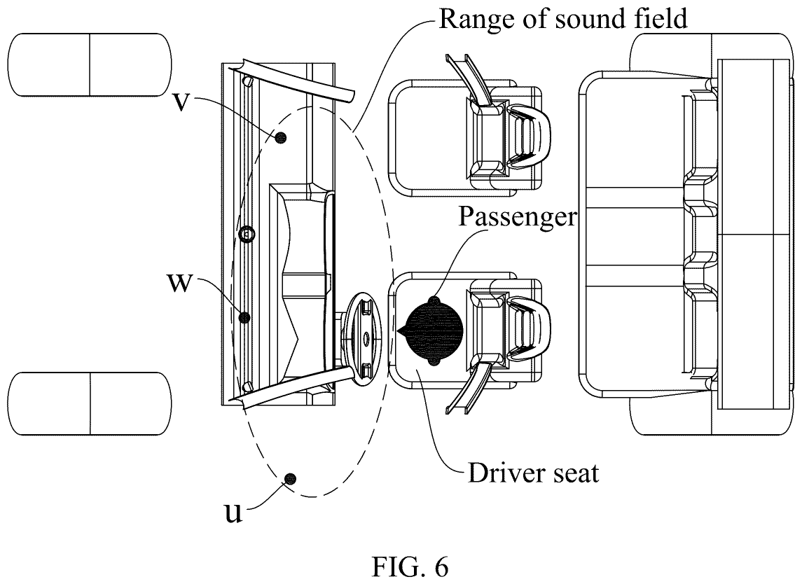

It can be understood that the sound field reconstruction at each seat in the cabin is based on the fact that the actual acoustic response is consistent with the ideal acoustic response. That is, the sound system 400 may control each speaker 420 to perform the sound reproduction of the audio signal to be played based on the sound field reconstruction result at each seat, and the actual acoustic response at each seat will be consistent with the ideal acoustic response of the listening room. That is, for the passenger sitting on each seat, the acoustic energy/sound field between the two ears is balanced, the size of the sound field of the passenger is at least consistent with the physical layout of the speaker 420 in the cabin, and may even break through the physical space limitation of the cabin, the sound field of the passenger still does not have an obvious fault, thereby sufficiently taking account of the size of the sound field and the sound field size and the sound energy/sound field balance between the two ears of the passenger to improve the acoustic experience of the passenger at each seat in the cabin. In order to clearly understand the beneficial effects brought by the method for optimizing in-vehicle sound field of the present disclosure, referring to FIG. 6, still taking the passenger on the driver seat as an example, the elliptical shadow area also represents the range of the sound field perceived by the passenger, u, v and w also respectively represent the left-channel sound image position, the right-channel sound image position and the central sound image position perceived by the passenger. It can be found from FIG. 6 that after the optimization by the method for optimizing in-vehicle sound field, the ideal acoustic environment of the listening room is fully restored, and the left-channel sound image position u and the right-channel sound image position v perceived by the passenger are respectively located on the left and right sides of the passenger and have good symmetry, which ensures the sound energy/sound field balance between the two ears of the passenger, and does not sacrifice the size of the sound field. That means, the sound field size is at least consistent with the physical layout of the speaker 420 in the cabin, so that the size of the sound field and the sound energy/sound field balance between the two ears of the passenger can be taken into account, and the acoustic experience of the passenger at each seat in the cabin is improved. In addition, it should be noted that, when reconstructing the sound field at each seat, although it is based on that the actual acoustic response is consistent with the ideal acoustic response, after the sound field reconstruction is completed, the actual acoustic response at a single seat is not completely equivalent to the ideal acoustic response, and the method for optimizing in-vehicle sound field of the present disclosure is actually a process of seeking a best sound field reconstruction result at each seat. As a result, when each speaker 420 is controlled to perform sound reproduction of the audio signal to be played based on the best sound field reconstruction result at each seat, a difference between the actual acoustic response and the ideal acoustic response at each seat is minimum.

In one embodiment, the flow of the domain controller 410 calculating the actual acoustic response at the target seat includes: acquiring a left-channel sound source and a right-channel sound source of a preset audio signal, and analyzing a first audio component having high correlation between the left-channel sound source and the right-channel sound source, a second audio component having low correlation with the right-channel sound source in the left-channel sound source, and a third audio component having low correlation with the left-channel sound source in the right-channel sound source; calculating the actual acoustic response at the target seat according to the first audio component, the left-channel sound source, the third audio component, the electro-acoustic conversion transfer function of each speaker 420, the first acoustic transfer function of each digital filter, and the second acoustic transfer function from each speaker 420 to the target seat in the cabin. Correspondingly, the flow of the domain controller 410 calculating the ideal acoustic response at the best listening position 520 includes: calculating the ideal acoustic response at the optimal listening position 520 according to the first audio component, the second audio component, the third audio component, the ideal acoustic transfer function from each preset speaker 510 in the listening room to the best listening position 520, and the ideal electro-acoustic conversion transfer function of each preset speaker 510.

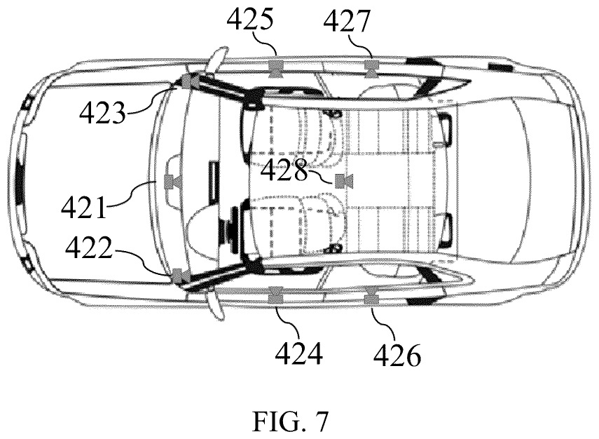

In some embodiments, as shown in FIG. 7, eight speakers 420 are provided in the cabin. The speakers include a first speaker 421, a second speaker 422, a third speaker 423, a fourth speaker 424, a fifth speaker 425, a sixth speaker 426, a seventh speaker 427 and an eighth speaker 428. The first speaker 421 is located at a center position of the central console, the second speaker 422 is located on one side of the central console adjacent to the driver seat, the third speaker 423 is located on the other side of the central console adjacent to the passenger seat, the fourth speaker 424 is located on a left front door of the automobile, the fifth speaker 425 is located on a right front door of the automobile, the sixth speaker 426 is located on a left rear door of the automobile, the seventh speaker 427 is located on a right rear door of the automobile, and the eighth speaker 428 is located between the rear left seat and the rear right seat. Taking the driver seat as an example, the first speaker 421, the second speaker 422, the third speaker 423, the fourth speaker 424, and the fifth speaker 425 have the greatest influence on the sound field of the driver seat, and the sixth speaker 426, the seventh speaker 427, and the eighth speaker 428 have little influence on the sound field of the driving seat. In actual modeling, it may or may not be incorporated into calculation, for example, it is determined by design developers according to actual conditions, which is not limited in the present disclosure. The present disclosure only considers the first speaker 421, the second speaker 422, the third speaker 423, the fourth speaker 424, and the fifth speaker 425 for the driver seat.

Assuming that input signals of the first speaker 421, the second speaker 422, the third speaker 423, the fourth speaker 424, and the fifth speaker 425 are S₁, S₂, S₃, S₄, S₅, respectively, then:

$${S}_{1} = C ( t ) ,$$

$${S}_{2} = L ( t ) ,$$

$${S}_{3} = R ( t ) ,$$

$${S}_{4} = L ( t ) - C ( t ) ,$$

$${S}_{5} = R ( t ) - C ( t ) ;$$

where L(t) represents the left-channel sound source of the preset audio signal, and R(t) represents the right-channel sound source of the preset audio signal. For example, C(t) is expressed as:

$${C ( t ) = E [ L ( t ) ] {\vert}_{r s q \geq {R}_{L R}}^{{f}_{1} \leq f \leq {f}_{2}} + E [ R ( t ) ] \vert }_{r s q \geq {R}_{L R}}^{{f}_{1} \leq f \leq {f}_{2}} ;$$

where

$$E [ ] {\vert}_{r s q \geq {R}_{L R}}^{{f}_{1} \leq f \leq {f}_{2}}$$

represents that the first audio component with high correlation between the frequency range of the left-channel sound source and the frequency range of the right-channel sound source between f1 and f2 is extracted from the preset audio signal, and the correlation between the left-channel sound source and the right-channel sound source is calculated by using the square value of the correlation coefficient of the Pearson product moment, which is denoted as rsq in the above formula. In the above formula, R_{LR}=0.8, f₁=250 Hz, f₂=8000 Hz, based on which C(t) may be rewritten into the following form:

$$C ( t ) = {\sum }_{n = 0}^{1} E [ {x}_{n} , f , rsq ] {\vert}_{rsq \geq 0.8}^{250 Hz \leq f \leq 8000 H z} ;$$

$$where$$

$${x}_{0} = L ( t ) , {x}_{1} = R ( t ) .$$

Therefore, the left-channel sound source of the preset audio signal may be rewritten as:

$$L ( t ) = C ( t ) + [ L ( t ) - C ( t ) ] ;$$

C(t) represents a first audio component with relatively high correlation between the left-channel sound source and the right-channel sound source, and [L(t)−C(t)] is a second audio component with relatively low correlation between the left-channel sound source and the right-channel sound source.

The right-channel sound source of the preset audio signal may also be rewritten as:

$$R ( t ) = C ( t ) + [ R ( t ) - C ( t ) ] ;$$

where [R(t)−C(t)] represents a third audio component that has a low correlation with the left-channel sound source in the right-channel sound source.

The actual acoustic response at the driver seat may then be expressed as:

$$C ( t ) \cdot [ \begin{matrix}{H}_{1}^{filter} & {H}_{2}^{filter} & {H}_{3}^{filter}\end{matrix} ] \cdot [ \begin{matrix}{h}_{1} & 0 & 0 \\ 0 & {h}_{2} & 0 \\ 0 & 0 & {h}_{3}\end{matrix} ] \cdot {[ \begin{matrix}{H}_{1} & {H}_{2} & {H}_{3}\end{matrix} ]}^{T} ;$$

$$[ L ( t ) - C ( t ) ] \cdot [ \begin{matrix}{H}_{2}^{filter} & {H}_{4}^{filter}\end{matrix} ] \cdot [ \begin{matrix}{h}_{2} & 0 \\ 0 & {h}_{4}\end{matrix} ] \cdot {[ \begin{matrix}{H}_{2} & {H}_{4}\end{matrix} ]}^{T} ;$$

$$[ R ( t ) - C ( t ) ] \cdot [ \begin{matrix}{H}_{3}^{filter} & {H}_{5}^{filter}\end{matrix} ] \cdot [ \begin{matrix}{h}_{3} & 0 \\ 0 & {h}_{5}\end{matrix} ] \cdot {[ \begin{matrix}{H}_{3} & {H}_{5}\end{matrix} ]}^{T} ;$$

where H₁^{filter}, H₂^{filter}, H₃^{filter}, H₄^{filter}, and H₅^{filter} respectively represent the first acoustic transfer functions of the digital filters of the first speaker 421, the second speaker 422, the fourth speaker 424, the third speaker 423, and the fifth speaker 425, H₁, H₂, H₃, H₄, and H₅ respectively represent the second acoustic transfer functions from the first speaker 421, the second speaker 422, the fourth speaker 424, the third speaker 423, and the fifth speaker 425 to the driver seat, h₁, h₂, h₃, h₄, and h₅ respectively represent the electro-acoustic conversion transfer functions of the first speaker 421, the second speaker 422, the fourth speaker 424, the third speaker 423, and the fifth speaker 425. In addition, it should be noted that the transfer function refers to the ratio of the Laplace transform (or z-transform) of the linear system response (i.e., output) quantity to the Laplace transform of the excitation (i.e., input) quantity at zero initial condition, which is one of the basic mathematical tools for describing the dynamic characteristics of the linear system, and is one of the main tools for studying the classical control theory.

In some embodiments, as shown in FIG. 5, there are three preset speakers 510 in the listening room, namely, a left-channel speaker 511, a middle speaker 512, and a right-channel speaker 513, respectively. Then, the ideal acoustic response at the best listening position 520 may be expressed as:

$$C ( t ) \cdot [ \begin{matrix}{h}_{L} & 0 & 0 \\ 0 & {h}_{C} & 0 \\ 0 & 0 & {h}_{R}\end{matrix} ] \cdot {[ \begin{matrix}{H}_{L} & {H}_{C} & {H}_{R}\end{matrix} ]}^{T} ;$$

$$[ L ( t ) - C ( t ) ] \cdot {h}_{L} \cdot {H}_{L} ;$$

$$[ R ( t ) - C ( t ) ] \cdot {h}_{R} \cdot {H}_{R} ;$$

where [ ]^{T} represents transpose calculation of the matrix, H_{L}, H_{C}, and H_{R} represent ideal acoustic transfer functions from the left-channel speaker 511, the middle speaker 512, and the right-channel speaker 513 to the best listening position 520 respectively, and h_{L}, h_{C}, and h_{R} represent ideal electro-acoustic conversion transfer functions of the left-channel speaker 511, the middle speaker 512, and the right-channel speaker 513 respectively.

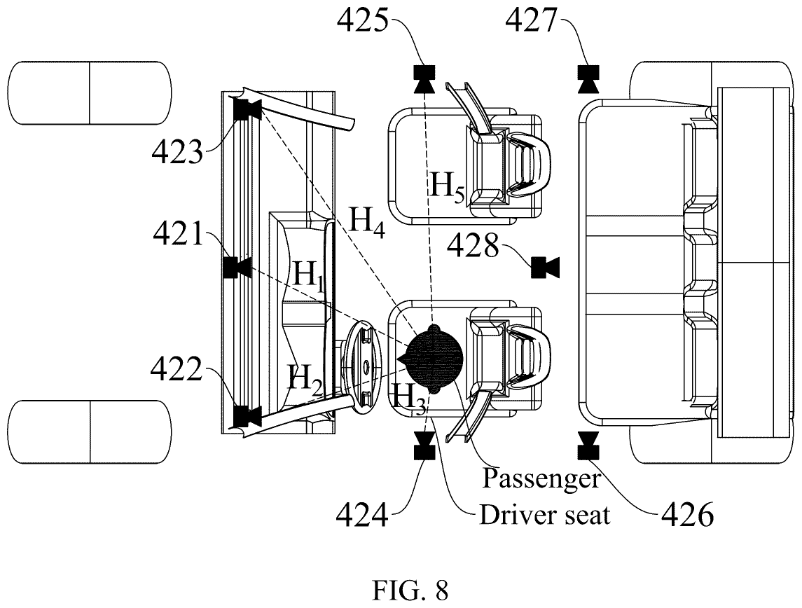

Based on the above description of this embodiment, as shown in FIG. 8, after the sound field at the driver seat is reconstructed, the sound field reconstruction result at the driver seat may be expressed as:

$$\vert \begin{matrix}C ( t ) \cdot [ \begin{matrix}{H}_{1}^{filter} & {H}_{2}^{filter} & {H}_{3}^{filter}\end{matrix} ] \cdot [ \begin{matrix}{h}_{1} & 0 & 0 \\ 0 & {h}_{2} & 0 \\ 0 & 0 & {h}_{3}\end{matrix} ] \cdot {[ \begin{matrix}{H}_{1} & {H}_{2} & {H}_{3}\end{matrix} ]}^{T} \\ - C ( t ) \cdot [ \begin{matrix}{h}_{L} & 0 & 0 \\ 0 & {h}_{C} & 0 \\ 0 & 0 & {h}_{R}\end{matrix} ] \cdot {[ \begin{matrix}{H}_{L} & {H}_{C} & {H}_{R}\end{matrix} ]}^{T}\end{matrix} \vert = 0 ;$$

$$\vert [ L ( t ) - C ( t ) ] \cdot [ \begin{matrix}{H}_{2}^{filter} & {H}_{4}^{filter}\end{matrix} ] \cdot [ \text{} \begin{matrix}{h}_{2} & 0 \\ 0 & {h}_{4}\end{matrix} ] \cdot {[ \begin{matrix}{H}_{2} & {H}_{4}\end{matrix} ]}^{T} - [ \text{} L ( t ) - C ( t ) ] - {h}_{L} \cdot {H}_{L} \vert = 0 ;$$

$$\vert [ R ( t ) - C ( t ) ] \cdot [ \text{} \begin{matrix}{H}_{3}^{filter} & {H}_{5}^{filter}\end{matrix} ] \cdot [ \text{} \begin{matrix}{h}_{3} & 0 \\ 0 & {h}_{5}\end{matrix} ] \cdot {[ \begin{matrix}{H}_{3} & {H}_{5}\end{matrix} ]}^{T} - [ \text{} R ( t ) - C ( t ) ] \cdot {h}_{R} \cdot {H}_{R} \vert = 0 ;$$

where | | represents the modulus for calculating the vector.

Generally, if only the sound field at a single seat in the cabin is reconstructed, for example, only the sound field at the driver seat is reconstructed, the H₁^{filter}, the H₂^{filter}, the H₃^{filter}, the H₄^{filter}, and the H₅^{filter} in the above formula have solutions, and the solutions of the H₁^{filter} the H₂^{filter}, the H₃^{filter}, the H₄^{filter}, and the H₅^{filter} are irrelevant to the left-channel sound source and the right-channel sound source of the preset audio signal. That is, the sound system 400 may be designed, and if the sound field at all seats in the cabin is reconstructed, in most cases, it is impossible to make each seat meet the requirements of the above formula. Therefore, in order to make each seat in the cabin have a better sound field reconstruction effect, the above formula may be rewritten into the following optimal form:

$$Min \{ \vert [ \begin{matrix}{H}_{1}^{filter} & {H}_{2}^{filter} & {H}_{3}^{filter}\end{matrix} ] \cdot \text{} [ \begin{matrix}{h}_{1} & 0 & 0 \\ 0 & {h}_{2} & 0 \\ 0 & 0 & {h}_{3}\end{matrix} ] \cdot [ \begin{matrix}{H}_{1} \\ {H}_{2} \\ {H}_{3}\end{matrix} ] - [ \begin{matrix}{h}_{L} & 0 & 0 \\ 0 & {h}_{C} & 0 \\ 0 & 0 & {h}_{R}\end{matrix} ] \cdot [ \begin{matrix}{H}_{L} \\ {H}_{C} \\ {H}_{R}\end{matrix} ] \vert \} ;$$

$$Min \{ \vert [ \begin{matrix}{H}_{2}^{filter} & {H}_{4}^{filter} ]\end{matrix} \cdot [ \begin{matrix}{h}_{2} & 0 \\ 0 & {h}_{4}\end{matrix} ] \cdot {[ \begin{matrix}{H}_{2} & {H}_{4}\end{matrix} ]}^{T} - {h}_{L} \cdot {H}_{L} \vert \} ;$$

$$Min \{ \vert [ \begin{matrix}{H}_{3}^{filter} & {H}_{5}^{filter} ]\end{matrix} \cdot [ \begin{matrix}{h}_{3} & 0 \\ 0 & {h}_{5}\end{matrix} ] \cdot {[ \begin{matrix}{H}_{3} & {H}_{5}\end{matrix} ]}^{T} - {h}_{R} \cdot {H}_{R} \vert \} .$$

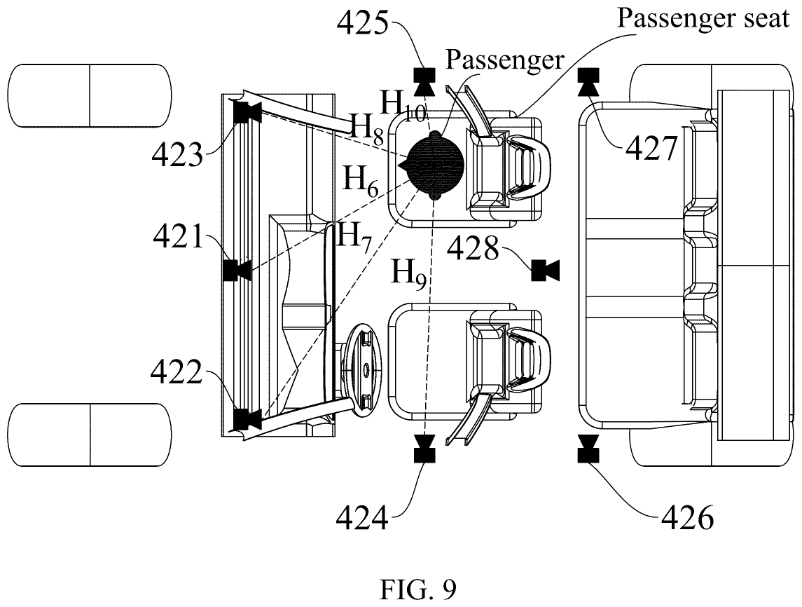

Similarly, as shown in FIG. 9, the sound field reconstruction result at the passenger seat may be expressed as:

$$Min \{ \vert [ \text{} \begin{matrix}{H}_{1}^{filter} & {H}_{2}^{filter} & {H}_{3}^{filter}\end{matrix} ] \cdot [ \text{} \begin{matrix}{h}_{1} & 0 & 0 \\ 0 & {h}_{2} & 0 \\ 0 & 0 & {h}_{3}\end{matrix} ] \cdot [ \text{} \begin{matrix}{H}_{6} \\ {H}_{7} \\ {H}_{8}\end{matrix} ] - [ \text{} \begin{matrix}{h}_{L} & 0 & 0 \\ 0 & {h}_{C} & 0 \\ 0 & 0 & {h}_{R}\end{matrix} ] \cdot [ \text{} \begin{matrix}{H}_{L} \\ {H}_{C} \\ {H}_{R}\end{matrix} ] \vert \} ;$$

$$Min \{ \vert [ \begin{matrix}{H}_{2}^{filter} & {H}_{4}^{filter} ]\end{matrix} \cdot [ \begin{matrix}{h}_{2} & 0 \\ 0 & {h}_{4}\end{matrix} ] \cdot {[ \begin{matrix}{H}_{7} & {H}_{9}\end{matrix} ]}^{T} - {h}_{L} \cdot {H}_{L} \vert \} ;$$

$$Min \{ \vert [ \begin{matrix}{H}_{3}^{filter} & {H}_{5}^{filter} ]\end{matrix} \cdot [ \begin{matrix}{h}_{3} & 0 \\ 0 & {h}_{5}\end{matrix} ] \cdot {[ \begin{matrix}{H}_{8} & {H}_{10}\end{matrix} ]}^{T} - {h}_{R} \cdot {H}_{R} \vert \} .$$

where H₆, H₇, H₈, H₉, and H₁₀ respectively represent the second acoustic transfer functions from the first speaker 421, the second speaker 422, the third speaker 423, the fourth speaker 424, and the fifth speaker 425 to the passenger seat.

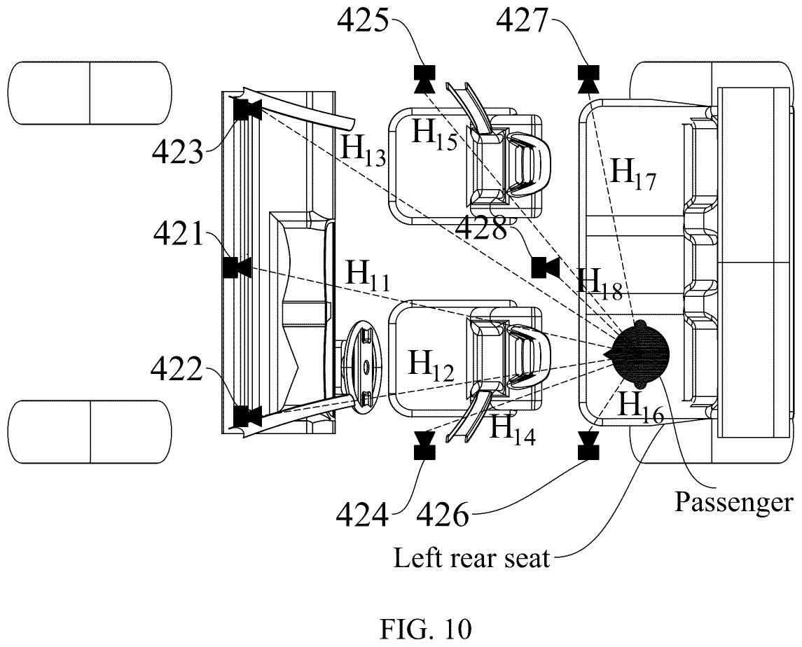

Similarly, as shown in FIG. 10, the sound field reconstruction result at the rear left seat may be expressed as:

$$Min \{ \vert [ \begin{matrix}{H}_{1}^{filter} & {H}_{2}^{filter} & {H}_{3}^{filter} & {H}_{6}^{filter}\end{matrix} ] \cdot [ \text{} \begin{matrix}{h}_{1} & 0 & 0 & 0 \\ 0 & {h}_{2} & 0 & 0 \\ 0 & 0 & {h}_{3} & 0 \\ 0 & 0 & 0 & {h}_{6}\end{matrix} ] \cdot [ \text{} \begin{matrix}{H}_{11} \\ {H}_{12} \\ {H}_{13} \\ {H}_{18}\end{matrix} ] - [ \text{} \begin{matrix}{h}_{L} & 0 & 0 \\ 0 & {h}_{C} & 0 \\ 0 & 0 & {h}_{R}\end{matrix} ] \cdot [ \text{} \begin{matrix}{H}_{L} \\ {H}_{C} \\ {H}_{R}\end{matrix} \text{} ] \vert \} ;$$

$$Min \{ \vert [ \begin{matrix}{H}_{2}^{filter} & {H}_{4}^{filter} & {H}_{7}^{filter} & ]\end{matrix} \cdot [ \begin{matrix}{h}_{2} & 0 & 0 \\ 0 & {h}_{4} & 0 \\ 0 & 0 & {h}_{7}\end{matrix} ] \cdot {[ \begin{matrix}{H}_{12} & {H}_{14} & {H}_{16}\end{matrix} ]}^{T} - {h}_{L} \cdot {H}_{L} \vert \} ;$$

$$Min \{ \vert [ \begin{matrix}{H}_{3}^{filter} & {H}_{4}^{filter} & {H}_{8}^{filter} & ]\end{matrix} \cdot [ \text{} \begin{matrix}{h}_{3} & 0 & 0 \\ 0 & {h}_{5} & 0 \\ 0 & 0 & {h}_{8}\end{matrix} ] \cdot {[ \begin{matrix}{H}_{13} & {H}_{15} & {H}_{17}\end{matrix} ]}^{T} - {h}_{R} \cdot {H}_{R} \vert \} ;$$

where H₆^{filter}, H₇^{filter}, and H₆^{filter} respectively represent first acoustic transfer functions of digital filters of the eighth speaker 428, the sixth speaker 426, and the seventh speaker 427, h₆, h₇ and h₈ respectively represent electro-acoustic conversion transfer functions of the eighth speaker 428, the sixth speaker 426, and the seventh speaker 427, H₁₁, H₁₂, H₁₃, H₁₄, H₁₅, H₁₆, H₁₇ and H₁₈ respectively represent second acoustic transfer functions from the first speaker 421, the second speaker 422, the third speaker 423, the fourth speaker 424, the fifth speaker 425, the sixth speaker 426, the seventh speaker 427, and the eighth speaker 428 to the rear left seat.

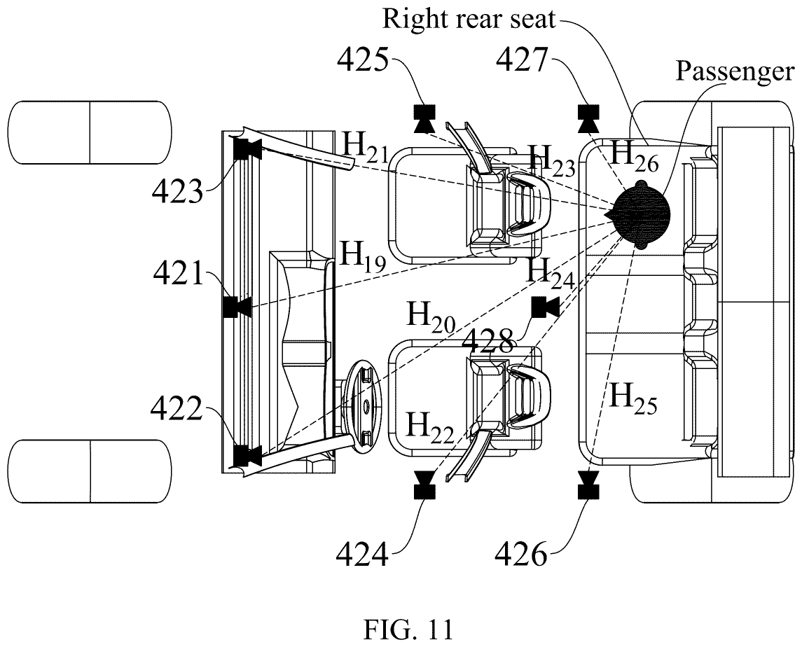

Similarly, as shown in FIG. 11, the sound field reconstruction result at the rear right seat may be expressed as:

$$Min \{ \vert \begin{matrix}[ \text{} \begin{matrix}{H}_{1}^{filter} & {H}_{2}^{filter} & {H}_{3}^{filter} & {H}_{6}^{filter}\end{matrix} ] \cdot [ \text{} \begin{matrix}{h}_{1} & 0 & 0 & 0 \\ 0 & {h}_{2} & 0 & 0 \\ 0 & 0 & {h}_{3} & 0 \\ 0 & 0 & 0 & {h}_{6}\end{matrix} ] \cdot [ \text{} \begin{matrix}{H}_{19} \\ {H}_{20} \\ {H}_{21} \\ {H}_{24}\end{matrix} ] \\ - [ \text{} \begin{matrix}{h}_{L} & 0 & 0 \\ 0 & {h}_{C} & 0 \\ 0 & 0 & {h}_{R}\end{matrix} ] \cdot [ \text{} \begin{matrix}{H}_{L} \\ {H}_{C} \\ {H}_{R}\end{matrix} \text{} ]\end{matrix} \vert \} ;$$

$$Min \{ \vert [ \begin{matrix}{H}_{2}^{filter} & {H}_{4}^{filter} & {H}_{7}^{filter}\end{matrix} ] \cdot [ \text{} \begin{matrix}{h}_{2} & 0 & 0 \\ 0 & {h}_{4} & 0 \\ 0 & 0 & {h}_{7}\end{matrix} ] \cdot {[ \begin{matrix}{H}_{20} & {H}_{22} & {H}_{25}\end{matrix} ]}^{T} - {h}_{L} \cdot {H}_{L} \vert \} ;$$

$$Min \{ \vert [ \begin{matrix}{H}_{3}^{filter} & {H}_{5}^{filter} & {H}_{8}^{filter}\end{matrix} ] \cdot [ \text{} \begin{matrix}{h}_{3} & 0 & 0 \\ 0 & {h}_{5} & 0 \\ 0 & 0 & {h}_{8}\end{matrix} ] \cdot {[ \begin{matrix}{H}_{21} & {H}_{23} & {H}_{26}\end{matrix} ]}^{T} - {h}_{R} \cdot {H}_{R} \vert \} ;$$

where H₁₉, H₂₀, H₂₁, H₂₂, H₂₃, H₂₄, H₂₅, and H₂₆ respectively represent the second acoustic transfer functions from the first speaker 421, the second speaker 422, the third speaker 423, the fourth speaker 424, the fifth speaker 425, the eighth speaker 428, the sixth speaker 426, and the seventh speaker 427 to the rear right seat.

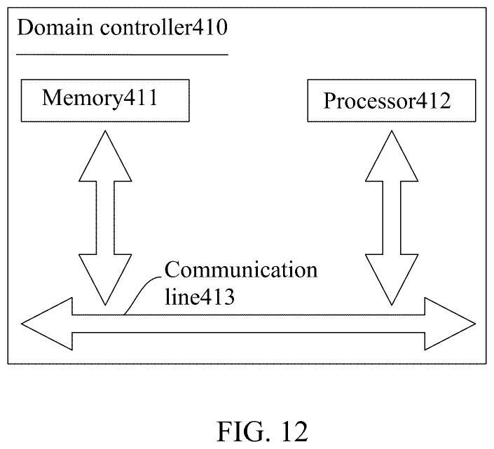

In an embodiment, FIG. 12 is a block diagram of modules of a domain controller, the domain controller 410 includes a memory 411 and a processor 412, the memory 411 is communicatively connected with the processor 412, a computer program is stored in the memory 411, the computer program is a method for optimizing in-vehicle sound field in the present disclosure. That is, the processor 412 may call the computer program stored in the memory 411 to realize the method for optimizing in-vehicle sound field. In addition, it should be noted that, in addition to the memory 411 and the processor 412, the domain controller 410 may further include another structure commonly used in the art, for example, a communication line 413 configured to implement a communication connection between the memory 411 and the processor 412, which is not listed in the present disclosure.

In some embodiments, the processor 412 is composed of an integrated circuit, and may be composed of a single packaged integrated circuit, or may be composed of a plurality of integrated circuits packaged with the same function or different functions, and the processor 412 may include any one or a combination of a central processing unit (CPU), a microprocessor, a neural network chip, a digital processing chip, a graphics processor, and various control chips. It may be understood that the processor 412 belongs to a control core of the domain controller 410, and the processor 412 connects various components of the entire domain controller 410 by using various interfaces and lines, and implements various functions and data processing of the domain controller 410 by running or executing a computer program or module and calling data, for example, implementing the in-vehicle sound field optimization function in the present disclosure.

In some embodiments, the memory 411 includes at least one type of computer-readable storage medium, and the computer-readable storage medium may include, but is not limited to, a flash memory, a mobile hard disk, a multimedia card, a card-type memory (such as an SD memory or a DX memory), a magnetic memory, a magnetic disk, and an optical disk. In these implementations, the memory 411 may be an internal storage unit of the domain controller 410 (for example, a mobile hard disk of the domain controller 410), or may be an external storage device of the domain controller 410, for example, a plug-in mobile hard disk, an intelligent memory card (SMC), a secure digital (SD) card, a flash memory card, and the like that are provided on the domain controller 410, or the memory 411 is both an internal storage unit and an external storage device of the domain controller 410. Further, the memory 411 may be configured to not only store application software, various types of data, and a computer program (for example, code for implementing an in-vehicle sound field optimization function in the present disclosure) installed in the domain controller 410, but also temporarily store data that has been output or that is to be output; and in an actual working process of the domain controller 410, the processor 412 may call and run the computer program stored in the memory 411, to implement the in-vehicle sound field optimization function in the present disclosure.

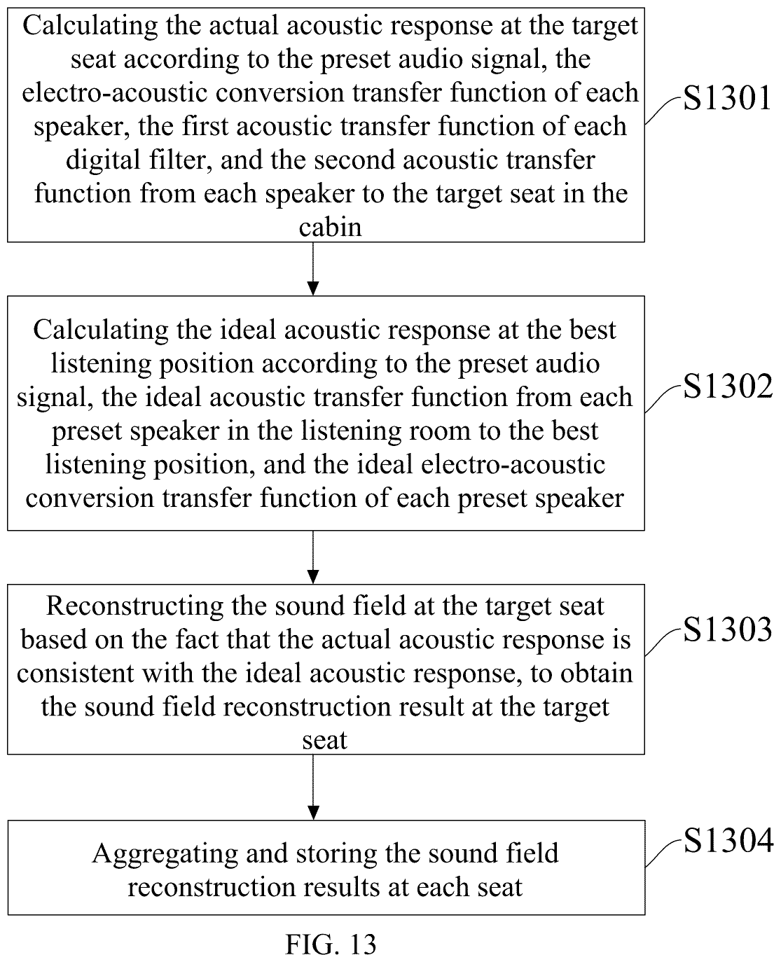

The above embodiments are merely preferred implementations of the present disclosure, and are not intended to limit related content such as the sound system 400 and the domain controller 410; In this regard, the skilled in the art may flexibly set according to the actual application scenarios on the basis of the above implementation examples. Hereinafter, a computer program (that is, the method for optimizing in-vehicle sound field) executed by the processor 412 in the domain controller 410 will be described in detail. FIG. 13 is a schematic flowchart of the method for optimizing in-vehicle sound field, and in some embodiments, the method for optimizing in-vehicle sound field includes step 1301 to step 1304 (abbreviated as S1301 to S1304), including:
S1301, calculating the actual acoustic response at the target seat according to the preset audio signal, the electro-acoustic conversion transfer function of each speaker 420, the first acoustic transfer function of each digital filter, and the second acoustic transfer function from each speaker 420 to the target seat in the cabin;
S1302, calculating the ideal acoustic response at the best listening position according to the preset audio signal, the ideal acoustic transfer function from each preset speaker 510 in the listening room to the best listening position 520, and the ideal electro-acoustic conversion transfer function of each preset speaker 510;
S1303, reconstructing the sound field at the target seat based on the fact that the actual acoustic response is consistent with the ideal acoustic response, to obtain the sound field reconstruction result at the target seat;
S1304, aggregating and storing the sound field reconstruction results at each seat.

In addition, it should be noted that, in S1303, the process of reconstructing the sound field at the target seat based on the fact that the actual acoustic response is consistent with the ideal acoustic response is essentially the process of fitting the target sound field at the target seat with the ideal sound field of the listening room, and fitted content may include but is not limited to amplitude response fitting, sound image positioning fitting, and uniformity fitting. It should be further noted that, for an incomplete part in the description of the method for optimizing in-vehicle sound field, it may be referred to the above related description of the sound system 400, and details are not described herein again.

The above embodiments are merely preferred implementations of the present disclosure, and are not intended to limit related content such as the method for optimizing in-vehicle sound field; In this regard, the skilled in the art may flexibly set according to the actual application scenarios on the basis of the above implementation examples. It may be understood that, through the embodiments of the above technical solutions of the present disclosure, the actual acoustic response at the target seat for each speaker 420 to play the preset audio signal is calculated according to the preset audio signal, the electro-acoustic conversion transfer function of each speaker 420 in the cabin, the first acoustic transfer function of each digital filter and the second acoustic transfer function from each speaker 420 to the target seat, and the ideal acoustic response at the best listening position 520 for each preset speaker 510 to play the preset audio signal is calculated according to the preset audio signal, the ideal acoustic transfer function from each preset speaker 510 in the listening room to the best listening position 520 and the ideal electro-acoustic conversion transfer function of each preset speaker 510, then the sound field at the target seat is reconstructed based on the fact that the actual acoustic response is consistent with the ideal acoustic response to obtain the sound field reconstruction result at the target seat, finally the sound field reconstruction results at each seat is aggregated and stored to complete the optimization of the sound field in the cabin. It can be seen that the sound field reconstruction at each seat is based on the fact that the actual acoustic response is consistent with the ideal acoustic response, that is, the sound system 400 may control each speaker 420 to perform the sound reproduction of the audio signal to be played based on the sound field reconstruction result at each seat, and at this time, the actual acoustic response at each seat will be consistent with the ideal acoustic response of the listening room, that is, for the passenger sitting on each seat, the acoustic energy/sound field between the two ears is balanced. The size of the sound field of the passenger is at least consistent with the physical layout of the speaker 420 in the cabin, and even breaks through the physical space limitation of the cabin, and the sound field of the passenger does not have an obvious fault, thereby sufficiently taking account of the size of the sound field and the sound field size and the sound energy/sound field balance between the two ears of the passenger to improve the acoustic experience of the passenger at each seat in the cabin.

The steps of the method or algorithm described in connection with the embodiments disclosed herein may be implemented directly in hardware, a software module executed by a processor, or a combination thereof, where the software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

In the above embodiments, it may be implemented in whole or in part by software, hardware, firmware or any combination thereof. When implemented by using software, the computer program product may be implemented in whole or in part in a form of a computer program product, the computer program product includes one or more computer instructions, and when the computer instructions are loaded and executed on a computer, the processes or functions described in the present disclosure are generated in whole or in part, the computer may be a general-purpose computer, a special-purpose computer, a computer network, or another programmable device. The computer instructions may be stored in a computer-readable storage medium or transmitted from one computer-readable storage medium to another computer-readable storage medium, for example, the computer instructions may be transmitted from one website, computer, server or data center to another website, computer, server or data center in a wired (e.g., coaxial cable, optical fiber, digital subscriber line, etc.) or wireless (e.g., infrared, wireless, microwave, etc.) manner. The computer-readable storage medium may be any available medium accessible by a computer or a data storage device such as a server or a data center integrated by one or more available media. The usable medium may be a magnetic medium (such as a floppy disk, a hard disk, and a magnetic tape), an optical medium (such as a DVD), a semiconductor medium (such as a solid state disk), or the like.

It is to be noted that various embodiments in the present disclosure are described in a progressive manner, each of the embodiments is mainly described in terms of differences from further embodiments, and identical/similar parts between various embodiments refer to each other. It also should be noted that, in this context, relational terms such as “first” and “second” are only used to distinguish one entity or operation from another entity or operation, and do not necessarily require or imply any actual relationship or sequence between these entities or operations. In addition, terms such as “include”, “comprise” or any variants are meant to cover non-exclusive enclosure, so that the process, method, item or device comprising a series of elements not only include the elements listed but also may include other elements which are not specifically listed or the inherent elements of the process, method, item or device. Without more limitations, an element defined by the statement “including one” does not preclude the presence of another identical element in a process, method, article, or device that includes the element.

The above description of the embodiments of the present disclosure enables those skilled in the art to implement or use the present disclosure. Various modifications to the above-mentioned embodiments may be apparent to those skilled in the art, and the principles defined herein may be implemented in other embodiments without departing from the spirit or scope of the present disclosure. Therefore, the present disclosure is not limited to the embodiments shown in this specification but should conform to the widest scope consistent with the principles and novel features disclosed in the specification.

What is claimed is:

1. A method for optimizing in-vehicle sound field, applied to a sound system disposed in a cabin of an automobile, the sound system comprising a plurality of speakers located at different positions in the cabin, wherein the cabin is provided with a plurality of seats, and each speaker is provided with a digital filter, wherein the method for optimizing in-vehicle sound field comprises:
calculating an actual acoustic response at a target seat according to a preset audio signal, an electro-acoustic conversion transfer function of each speaker, a first acoustic transfer function of each digital filter, and a second acoustic transfer function from each speaker to the target seat in the cabin;
calculating an ideal acoustic response at a best listening position according to the preset audio signal, an ideal acoustic transfer function from each preset speaker in a listening room to an optimal listening position, and an ideal electro-acoustic conversion transfer function of each preset speaker;
reconstructing the sound field at the target seat based on that the actual acoustic response is consistent with the ideal acoustic response, to obtain a sound field reconstruction result at the target seat; and
aggregating and storing the sound field reconstruction results for each seat.

2. The method for optimizing in-vehicle sound field as described in claim 1, wherein the calculating an actual acoustic response at the target seat according to the preset audio signal, the electro-acoustic conversion transfer function of each speaker, the first acoustic transfer function of each digital filter, and the second acoustic transfer function from each speaker to the target seat in the cabin comprises:
acquiring a left-channel sound source and a right-channel sound source of a preset audio signal, and analyzing a first audio component having high correlation between the left-channel sound source and the right-channel sound source, a second audio component having low correlation with the right-channel sound source in the left-channel sound source, and a third audio component having low correlation with the left-channel sound source in the right-channel sound source; and
calculating the actual acoustic response at the target seat according to the first audio component, the second audio component, the third audio component, the electro-acoustic conversion transfer function of each speaker, the first acoustic transfer function of each digital filter, and the second acoustic transfer function from each speaker to the target seat in the cabin;
wherein the calculating the ideal acoustic response at the best listening position according to the preset audio signal, the ideal acoustic transfer function from each preset speaker in the listening room to the best listening position, and the ideal electro-acoustic conversion transfer function of each preset speaker comprises:
calculating the ideal acoustic response at the optimal listening position according to the first audio component, the second audio component, the third audio component, the ideal acoustic transfer function from each preset speaker in the listening room to the best listening position, and the ideal electro-acoustic conversion transfer function of each preset speaker.

3. The method for optimizing in-vehicle sound field as described in claim 2, wherein the cabin is further provided with a central console close to a head of the automobile and a table console close to a tail of the automobile, the plurality of seats comprise a driver seat, a passenger seat, a rear left seat and a rear right seat, wherein the driver seat and the passenger seat are arranged side by side and adjacent to the central console, and the rear left seat and the rear right seat are arranged side by side and adjacent to the table console;
the plurality of speakers comprise a first speaker, a second speaker, a third speaker, a fourth speaker, a fifth speaker, a sixth speaker, a seventh speaker and an eighth speaker, the first speaker is located at a center position of the central console, the second speaker is located on one side of the central console adjacent to the driver seat, the third speaker is located on the other side of the central console adjacent to the passenger seat, the fourth speaker is located on a left front door of the automobile, the fifth speaker is located on a right front door of the automobile, the sixth speaker is located on a left rear door of the automobile, the seventh speaker is located on a right rear door of the automobile, and the eighth speaker is located between the rear left seat and the rear right seat.

4. The method for optimizing in-vehicle sound field as described in claim 3, wherein the preset speaker comprises a left-channel speaker, a middle speaker and a right-channel speaker, and the ideal acoustic response at the best listening position is expressed as:
$$C ( t ) \cdot [ \begin{matrix}{h}_{L} & 0 & 0 \\ 0 & {h}_{C} & 0 \\ 0 & 0 & {h}_{R}\end{matrix} ] \cdot {[ \begin{matrix}{H}_{L} & {H}_{C} & {H}_{R}\end{matrix} ]}^{T} ;$$
$$[ L ( t ) - C ( t ) ] \cdot {h}_{L} \cdot {H}_{L} ;$$
$$[ R ( t ) - C ( t ) ] \cdot {h}_{R} \cdot {H}_{R} ;$$
wherein [ ]^{T} is matrix transpose operation, L(t) represents the left-channel sound source, R(t) represents the right-channel sound source, C(t) represents the first audio component, [L(t)−C(t)] represents the second audio component, [R(t)−C(t)] represents the third audio component, H_{L}, H_{C}, and H_{R} respectively represent the ideal acoustic transfer functions from the left-channel speaker, the middle speaker, and the right-channel speaker to the best listening position, and h_{L}, h_{C}, and h_{R} respectively represent the ideal electro-acoustic conversion transfer functions from the left-channel speaker, the middle speaker, and the right-channel speaker.

5. The method for optimizing in-vehicle sound field as described in claim 4, wherein the actual acoustic response at the driver seat is expressed as:
$$C ( t ) \cdot [ \begin{matrix}{H}_{1}^{filter} & {H}_{2}^{filter} & {H}_{3}^{filter}\end{matrix} ] \cdot [ \begin{matrix}{h}_{1} & 0 & 0 \\ 0 & {h}_{2} & 0 \\ 0 & 0 & {h}_{3}\end{matrix} ] \cdot {[ \begin{matrix}{H}_{1} & {H}_{2} & {H}_{3}\end{matrix} ]}^{T} ;$$
$$[ L ( t ) - C ( t ) ] \cdot [ \begin{matrix}{H}_{2}^{filter} & {H}_{4}^{filter}\end{matrix} ] \cdot [ \begin{matrix}{h}_{2} & 0 \\ 0 & {h}_{4}\end{matrix} ] \cdot {[ \begin{matrix}{H}_{2} & {H}_{4}\end{matrix} ]}^{T} ;$$
$$[ R ( t ) - C ( t ) ] \cdot [ \begin{matrix}{H}_{3}^{filter} & {H}_{5}^{filter}\end{matrix} ] \cdot [ \begin{matrix}{h}_{3} & 0 \\ 0 & {h}_{5}\end{matrix} ] \cdot {[ \begin{matrix}{H}_{3} & {H}_{5}\end{matrix} ]}^{T} ;$$
wherein H₁^{filter}, H₂^{filter}, H₃^{filter}, H₄^{filter}, and H₅^{filter} respectively represent the first acoustic transfer functions of the digital filters of the first speaker, the second speaker, the fourth speaker, the third speaker, and the fifth speaker, H₁, H₂, H₃, H₄, and H₅ respectively represent the second acoustic transfer functions from the first speaker, the second speaker, the fourth speaker, the third speaker, and the fifth speaker to the driver seat, h₁, h₂, h₃, h₄, and h₅ respectively represent the electro-acoustic conversion transfer functions of the first speaker, the second speaker, the fourth speaker, the third speaker, and the fifth speaker.

6. The method for optimizing in-vehicle sound field as described in claim 5, wherein the sound field reconstruction result at the driver seat is expressed as:
$$Min \{ \vert [ \text{} \begin{matrix}{H}_{1}^{filter} & {H}_{2}^{filter} & {H}_{3}^{filter}\end{matrix} ] \cdot [ \text{} \begin{matrix}{h}_{1} & 0 & 0 \\ 0 & {h}_{2} & 0 \\ 0 & 0 & {h}_{3}\end{matrix} ] \cdot [ \text{} \begin{matrix}{H}_{1} \\ {H}_{2} \\ {H}_{3}\end{matrix} ] - [ \text{} \begin{matrix}{h}_{L} & 0 & 0 \\ 0 & {h}_{C} & 0 \\ 0 & 0 & {h}_{R}\end{matrix} ] \cdot [ \text{} \begin{matrix}{H}_{L} \\ {H}_{C} \\ {H}_{R}\end{matrix} \text{} ] \vert \} ;$$
$$Min \{ \vert [ \begin{matrix}{H}_{2}^{filter} & {H}_{4}^{filter} & ]\end{matrix} \cdot [ \begin{matrix}{h}_{2} & 0 \\ 0 & {h}_{4}\end{matrix} ] \cdot {[ \begin{matrix}{H}_{2} & {H}_{4}\end{matrix} ]}^{T} - {h}_{L} \cdot {H}_{L} \vert \} ;$$
$$Min \{ \vert [ \begin{matrix}{H}_{3}^{filter} & {H}_{5}^{filter} & ]\end{matrix} \cdot [ \text{} \begin{matrix}{h}_{3} & 0 \\ 0 & {h}_{5}\end{matrix} ] \cdot {[ \begin{matrix}{H}_{3} & {H}_{5}\end{matrix} ]}^{T} - {h}_{R} \cdot {H}_{R} \vert \} ;$$
wherein | | represents the modulus of the vector.

7. The method for optimizing in-vehicle sound field as described in claim 6, wherein the sound field reconstruction result at the passenger seat is expressed as:
$$Min \{ \vert [ \text{} \begin{matrix}{H}_{1}^{filter} & {H}_{2}^{filter} & {H}_{3}^{filter}\end{matrix} ] \cdot [ \text{} \begin{matrix}{h}_{1} & 0 & 0 \\ 0 & {h}_{2} & 0 \\ 0 & 0 & {h}_{3}\end{matrix} ] \cdot [ \text{} \begin{matrix}{H}_{6} \\ {H}_{7} \\ {H}_{8}\end{matrix} ] - [ \text{} \begin{matrix}{h}_{L} & 0 & 0 \\ 0 & {h}_{C} & 0 \\ 0 & 0 & {h}_{R}\end{matrix} ] \cdot [ \text{} \begin{matrix}{H}_{L} \\ {H}_{C} \\ {H}_{R}\end{matrix} \text{} ] \vert \} ;$$
$$Min \{ \vert [ \begin{matrix}{H}_{2}^{filter} & {H}_{4}^{filter} ]\end{matrix} \cdot [ \begin{matrix}{h}_{2} & 0 \\ 0 & {h}_{4}\end{matrix} ] \cdot {[ \begin{matrix}{H}_{7} & {H}_{9}\end{matrix} ]}^{T} - {h}_{L} \cdot {H}_{L} \vert \} ;$$
$$Min \{ \vert [ \begin{matrix}{H}_{3}^{filter} & {H}_{5}^{filter} ]\end{matrix} \cdot [ \begin{matrix}{h}_{3} & 0 \\ 0 & {h}_{5}\end{matrix} ] \cdot {[ \begin{matrix}{H}_{8} & {H}_{10}\end{matrix} ]}^{T} - {h}_{R} \cdot {H}_{R} \vert \} .$$
wherein H₆, H₇, H₈, H₉, and H₁₀ respectively represent the second acoustic transfer functions from the first speaker, the second speaker, the third speaker, the fourth speaker, and the fifth speaker to the passenger seat.

8. The method for optimizing in-vehicle sound field as described in claim 7, wherein the sound field reconstruction result at the rear left seat is expressed as:
$$Min \{ \vert [ \begin{matrix}{H}_{1}^{filter} & {H}_{2}^{filter} & {H}_{3}^{filter} & {H}_{6}^{filter} & ]\end{matrix} \cdot [ \text{} \begin{matrix}{h}_{1} & 0 & 0 & 0 \\ 0 & {h}_{2} & 0 & 0 \\ 0 & 0 & {h}_{3} & 0 \\ 0 & 0 & 0 & {h}_{6}\end{matrix} ] \cdot [ \text{} \begin{matrix}{H}_{11} \\ {H}_{12} \\ {H}_{13} \\ {H}_{18}\end{matrix} ] - [ \text{} \begin{matrix}{h}_{L} & 0 & 0 \\ 0 & {h}_{C} & 0 \\ 0 & 0 & {h}_{R}\end{matrix} ] \cdot [ \text{} \begin{matrix}{H}_{L} \\ {H}_{C} \\ {H}_{R}\end{matrix} \text{} ] \vert \} ;$$
$$Min \{ \vert [ \begin{matrix}{H}_{2}^{filter} & {H}_{4}^{filter} & {H}_{7}^{filter} & ]\end{matrix} \cdot [ \begin{matrix}{h}_{2} & 0 & 0 \\ 0 & {h}_{4} & 0 \\ 0 & 0 & {h}_{7}\end{matrix} ] \cdot {[ \begin{matrix}{H}_{12} & {H}_{14} & {H}_{16}\end{matrix} ]}^{T} - {h}_{L} \cdot {H}_{L} \vert \} ;$$
$$Min \{ \vert [ \begin{matrix}{H}_{3}^{filter} & {H}_{5}^{filter} & {H}_{8}^{filter} & ]\end{matrix} \cdot [ \begin{matrix}{h}_{3} & 0 & 0 \\ 0 & {h}_{5} & 0 \\ 0 & 0 & {h}_{8}\end{matrix} ] \cdot {[ \begin{matrix}{H}_{13} & {H}_{15} & {H}_{17}\end{matrix} ]}^{T} - {h}_{R} \cdot {H}_{R} \vert \} ;$$
wherein H₆^{filter}, H₇^{filter}, and H₈^{filter} are respectively the first acoustic transfer functions of the digital filters of the eighth speaker, the sixth speaker, and the seventh speaker, h₆, h₇, and h₈ respectively represent the electro-acoustic conversion transfer functions of the eighth speaker, the sixth speaker, and the seventh speaker, H₁₁, H₁₂, H₁₃, H₁₄, H₁₅, H₁₆, H₁₇, and H₁₈ respectively represent the second acoustic transfer functions from the first speaker, the second speaker, the third speaker, the fourth speaker, the fifth speaker, the sixth speaker, the seventh speaker, and the eighth speaker to the rear left seat.

9. The method for optimizing in-vehicle sound field as described in claim 8, wherein the sound field reconstruction result at the rear right seat is expressed as:
$$Min \{ \vert \begin{matrix}[ \text{} \begin{matrix}{H}_{1}^{filter} & {H}_{2}^{filter} & {H}_{3}^{filter} & {H}_{6}^{filter}\end{matrix} ] \cdot [ \text{} \begin{matrix}{h}_{1} & 0 & 0 & 0 \\ 0 & {h}_{2} & 0 & 0 \\ 0 & 0 & {h}_{3} & 0 \\ 0 & 0 & 0 & {h}_{6}\end{matrix} ] \cdot [ \text{} \begin{matrix}{H}_{19} \\ {H}_{20} \\ {H}_{21} \\ {H}_{24}\end{matrix} ] \\ - [ \text{} \begin{matrix}{h}_{L} & 0 & 0 \\ 0 & {h}_{C} & 0 \\ 0 & 0 & {h}_{R}\end{matrix} ] \cdot [ \text{} \begin{matrix}{H}_{L} \\ {H}_{C} \\ {H}_{R}\end{matrix} \text{} ]\end{matrix} \vert \} ;$$
$$Min \{ \vert [ \text{} \begin{matrix}{H}_{2}^{filter} & {H}_{4}^{filter} & {H}_{7}^{filter} & ]\end{matrix} \cdot [ \text{} \begin{matrix}{h}_{2} & 0 & 0 \\ 0 & {h}_{4} & 0 \\ 0 & 0 & {h}_{7}\end{matrix} ] \cdot {[ \begin{matrix}{H}_{20} & {H}_{22} & {H}_{25}\end{matrix} ]}^{T} - {h}_{L} \cdot {H}_{L} \vert \} ;$$
$$Min \{ \vert [ \text{} \begin{matrix}{H}_{3}^{filter} & {H}_{5}^{filter} & {H}_{8}^{filter} & ]\end{matrix} \cdot [ \text{} \begin{matrix}{h}_{3} & 0 & 0 \\ 0 & {h}_{5} & 0 \\ 0 & 0 & {h}_{8}\end{matrix} ] \cdot {[ \begin{matrix}{H}_{21} & {H}_{23} & {H}_{26}\end{matrix} ]}^{T} - {h}_{R} \cdot {H}_{R} \vert \} ;$$
wherein H₁₉, H₂₀, H₂₁, H₂₂, H₂₃, H₂₄, H₂₅, and H₂₆ respectively represent the second acoustic transfer functions from the first speaker, the second speaker, the third speaker, the fourth speaker, the fifth speaker, the eighth speaker, the sixth speaker, and the seventh speaker to the rear right seat.

10. The method for optimizing in-vehicle sound field as described in claim 1, further comprising:
controlling each speaker to perform the sound reproduction of the audio signal to be played based on the sound field reconstruction result of each seat.

11. A sound system, applied to an automobile, the sound system comprising a domain controller and a plurality of speakers respectively located at different positions in a cabin of the automobile and communicatively connected to the domain controller, wherein the domain controller is configured to implement the method for optimizing an in-vehicle sound field as described in claim 1.

12. A non-transitory computer-readable storage medium storing a computer program, and the computer program is configured to be called by a processor to implement the method for optimizing an in-vehicle sound field as described in claim 1.
